(19) United States
(12) Patent Application Publication
(10) Pub. No.: US 2008/0027647 A1
(43) Pub. Date: Jan. 31, 2008

(54) Collision Avoidance System

(75) Inventors: Darren William Ansell, Lancashire (GB); Peter Mark Kirkham, Lancashire (GB)

Correspondence Address: CROWELL & MORING LLP;INTELLECTUAL PROPERTY GROUP, P.O. BOX 14300, WASHINGTON, DC, 20044-4300, US

(73) Assignee: Bae Systems plc, London (GB)

(21) Appl. No.: 11/629,207

(22) PCT Filed: Jul. 5, 2005
(86) PCT No.: PCT/GB05/50103

§ 371 Date: Dec. 12, 2006

(30) Foreign Application Priority Data
Jul. 9, 2004 (EP) 04254146.6
Jul. 9, 2004 (GB) 0415400.1

(51) Int. Cl. G08G 1/16

(52) U.S. Cl. 701/301

(57) ABSTRACT

A method for avoiding a collision and a collision avoidance system for a host vehicle comprising detecting means adapted to detect an intruder vehicle within a predetermined region around the host vehicle and collect data on the intruder vehicle; means for predicting a projected path of the intruder vehicle in the host vehicle reference frame; means for determining a protection region around the host vehicle, and conflict determining means adapted to determine if the intruder vehicle projected path will intercept the host vehicle protection region and thereby determine if conflict exists between the host vehicle and the intruder vehicle.

The present invention relates to a method and a system for collision avoidance, and in particular but not exclusively, to a collision avoidance system for use in aircraft.

For flight safety, aircraft must avoid other aircraft within the surrounding air space and the avoidance of collisions is an important task for pilots. Unmanned aerial vehicles (UAVs) on the other hand require a system to enable them to sense and avoid other aircraft in the surrounding air space. The full potential of UAVs cannot be realised until they are proven to have the ability to do this effectively and reliably and so operate safely within unrestricted air space. Aviation authorities will not give approval for UAVs to enter routine flight in commercial air space unless the UAVs meet a requirement for full collision avoidance of other aircraft.

Currently, there are transponder-based systems for use in UAVs but these only aid in avoiding cooperating aircraft, i.e. those aircraft which use transponders. Friendly aircraft might emit an Identification Friend or Foe (IFF) signal which may include aircraft kinematics data. There is currently no system that aids UAVs to avoid aircraft without transponders (for example hot air balloons or missiles) or aircraft with inoperative transponders, and therefore there is no system that allows UAVs to fly unaided in unrestricted air space.

Accordingly, there is provided a method for avoiding a collision between a host vehicle and an intruder vehicle comprising the steps of: detecting an intruder vehicle within a predetermined region around the host vehicle and collecting data on the intruder vehicle position over time; predicting a projected path of the intruder vehicle using a quadratic extrapolation of the intruder vehicle position data; assigning a protection region around the host vehicle, and determining if the intruder vehicle projected path will intercept the host vehicle protection region and thereby determining if there will be a conflict.

Such a method of collision avoidance allows the host vehicle to detect other aircraft within the surrounding air space and to determine if a possible conflict exists. A conflict is said to exist between a host vehicle and an intruder vehicle when the minimum separation is less than a specified safety limit to prevent, for example, the jet stream of one aircraft affecting the other aircraft. The designation of a protection region around the host vehicle enables a safety limit to be set in the form of a desired miss distance between the vehicles, the miss distance taking into account characteristics of each aircraft, such as size and the likely range of weapon systems of the intruder aircraft.

Preferably, the method further comprises the step of calculating, on determination of the existence of conflict between the host vehicle and the intruder vehicle, an alteration of the host vehicle course such that the intruder vehicle projected path will not intercept the host vehicle protection region. Alternatively, the method further comprises the step of, on determining that there will be a conflict between the host vehicle and the intruder vehicle, assigning a protection zone around the intruder vehicle, and calculating an alteration of the host vehicle course such that the host vehicle will not intercept the intruder vehicle protection zone.

Once the existence of conflict is determined, the host vehicle must alter its course if it is to avoid the intruder vehicle. Alteration of the course of the host vehicle so that the intruder vehicle projected path does not intercept the host vehicle protection region ensures the host vehicle avoids the intruder vehicle with the required safety margin. Calculation of a host vehicle course alteration such that the host vehicle will not intercept the intruder vehicle protection zone requires a lower processing capacity than the calculation of a course alteration such that the intruder vehicle projected path will not intercept the host vehicle protection region.

The host vehicle course alteration may be output as a resolution vector to a display means or an automatic steering device.

The output of a resolution vector to a display means gives an operator a visual indication of the remedial action required to avoid the intruder aircraft. The output of the vector to an automatic steering device enables the automatic steering device to act on information provided by the collision avoidance system without requiring operator input.

Advantageously, the calculation of a host vehicle course alteration takes into account host vehicle characteristics and any course alterations that do not comply with these characteristics are discarded.

Vehicles are limited in possible manoeuvres by their ability, for example, to sustain sharp turns. It is therefore preferable for these limitations to be taken into account and only a course alteration which is suitable and/or practicable provided. Any course alterations which do not comply with the international standard rules of the air may be discarded. The requirement for terrain avoidance is also taken into account when a course alteration is selected.

The method may further comprise, in the event a conflict has been determined, the step of calculating the critical time at which the intruder vehicle projected path is closest to the host vehicle.

Conflict can then be determined to exist only when the calculated critical time is positive, i.e. when the critical time is in the future. This prevents unnecessary determination of the existence of conflict when the host vehicle is moving away from the intruder vehicle.

The method may further comprise the step of selecting a course alteration such that at least one of time expenditure, fuel expenditure or change in direction of the host vehicle resulting from the course alteration is minimised.

Choosing the least costly course alteration means there should be more manoeuvrability available to the host vehicle to avoid new situations, such as the intruder vehicle changing course or the detection of further intruders.

On the detection of an intruder vehicle within the host vehicle protection region, it is preferable for an emergency course alteration to be selected.

If an intruder vehicle is detected within the host vehicle protection region, it is deemed to be too close to the host vehicle for safety. The host vehicle could therefore follow an emergency course, in order to remove the intruder vehicle from the host vehicle protection region, and this may effected by an automatic steering device, or autopilot.

The method may further comprise the step of storing multiple intruder vehicle position data. This enables all intruder conflicts within the predetermined region around the host vehicle to be evaluated and manoeuvre constraints to be calculated for all intruder vehicles that the host vehicle has data for, thereby preventing the calculation of a host vehicle course alteration which will avoid one intruder vehicle currently in conflict with the host vehicle but bring the host vehicle into conflict with another intruder vehicle.

According to another aspect of the present invention, there is provided a collision avoidance system for a host vehicle comprising detecting means adapted to detect an intruder vehicle within a predetermined region around the host vehicle and collect positional data on the intruder vehicle; means for predicting a projected path of the intruder vehicle using a quadratic extrapolation of the intruder vehicle positional data; means for determining a protection region around the host vehicle, and conflict determining means adapted to determine if the intruder vehicle projected path will intercept the host vehicle protection region and thereby determine the existence of conflict between the host vehicle and the intruder vehicle.

The invention also provides a vehicle having such a collision avoidance system.

The invention will now be described by way of example and with reference to the accompanying drawings, in which:

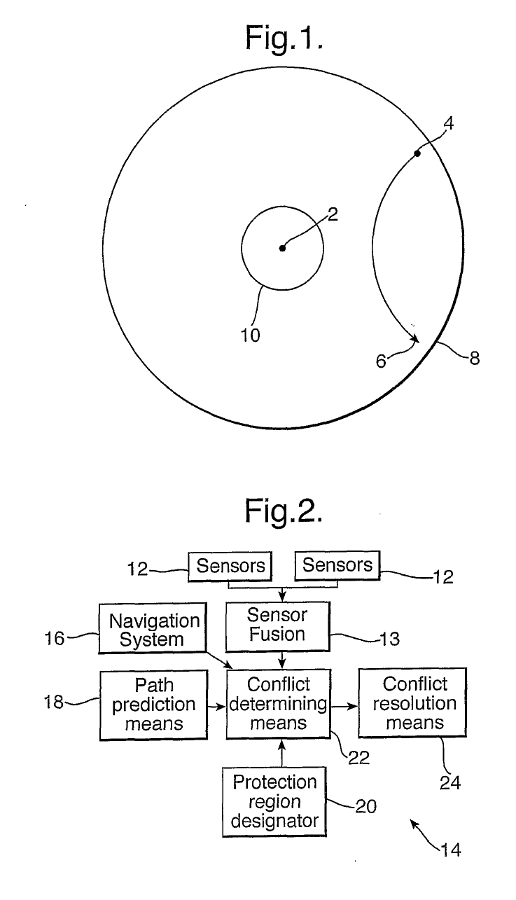

FIG. 1 is a schematic view of an intruder aircraft in a host aircraft reference frame;

FIG. 2 is a block diagram of an embodiment of a collision avoidance system in accordance with the invention, and

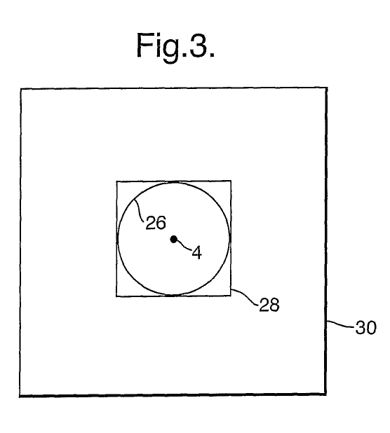

FIG. 3 illustrates the regions of space restricted by the manoeuvre constraints on a host aircraft.

FIG. 1 shows a host aircraft 2, equipped with a collision avoidance system (shown in FIG. 2), and an intruder aircraft 4 following a path 6 in the host vehicle reference frame within a region 8 of air space surrounding the host aircraft 2, the region 8 corresponding to the range of sensors incorporated in the collision avoidance system.

Referring to FIGS. 1 and 2, as the intruder aircraft 4 approaches the host aircraft 2, sensors 12 incorporated in the collision avoidance system 14 on the host aircraft 2, for example on-board radar systems, detect the intruder aircraft 4. Intruder aircraft data, for example position, direction and speed of the aircraft over time are captured, stored, and used to generate a projected path of the intruder aircraft. Positional information on cooperating intruder aircraft may be obtained from IFF data, GPS data or by some other means. Non-cooperating aircraft positional information may be obtained from on-board sensors. In either of these cases, the alternative sources of data can be received by the host aircraft 2, data from more than one sensor being fused by the sensor fusing means 13, and smoothed using the Kalman filtering process described below before being used to feed the collision avoidance system algorithm.

A navigation system 16 on board the host aircraft is used to provide global positioning satellite (GPS) data from which the host aircraft position is determined, in terms of an earth axis coordinate system to locate the host above a specific point on the earth's surface. This is then converted to a fixed frame coordinate system taking its positioning from the earth axis coordinate system at the time the intruder was first detected. The fixed frame coordinate system is typically taken to be a north-east-down (NED) Cartesian coordinate system, with the origin at the zero altitude point immediately below the host aircraft at the time of first detection of the intruder aircraft.

Future intruder aircraft positions are estimated in the earth axis coordinate system to generate a projected path 6 of the intruder aircraft. Kalman filtering is employed to remove some of the noise produced by using data supplied by the on-board radar thereby smoothing the data values to improve the estimate of the intruder aircraft state, e.g. position, velocity and acceleration. Extrapolation of the intruder aircraft position in a body axis coordinate system of the host aircraft incorporates the host aircraft velocity and acceleration. Any change in velocity or acceleration by the host aircraft would invalidate the state history of the Kalman filter on which the extrapolation was based. The extrapolation of the intruder position is therefore carried out by the path prediction means 18 in the earth axis coordinate system to ensure the predicted positions are independent of any host aircraft manoeuvres.

A fixed reference point in the fixed frame coordinate system is obtained for use in the calculation of the intruder aircraft acceleration, polar coordinate radar data being unable to provide the information due to the non-linear relationship between the polar data and the aircraft motion. The conversion to a fixed frame coordinate system ensures that manoeuvres of the host and intruder aircraft do not affect the calculation of the intruder aircraft acceleration.

The intruder aircraft position is then converted from the fixed frame coordinate system to a body axis coordinate system to give the intruder aircraft position relative to the host aircraft. Over time, the body axis coordinate system moves with the host aircraft; the origin of the fixed frame coordinate system remains as a fixed reference point until the intruder aircraft has passed out of the host aircraft detection range.

A collision detection algorithm is employed by the collision avoidance system 14 at regular time intervals to update the system with information on both the host and intruder aircraft, such as the aircraft positions. At each successive time frame while the intruder aircraft is within the detection range, host aircraft navigation data and intruder aircraft data are passed to the collision avoidance system processing means. The velocity and acceleration of both the host and intruder aircraft are calculated each time new data are supplied in order to maintain the accuracy of the predicted position of the intruder aircraft relative to the host aircraft.

Using the information previously obtained on the intruder aircraft state, the collision avoidance system 14 estimates a projected path 6 of the intruder aircraft 4 in the body axis coordinate system. Once the position and trajectory of the intruder aircraft 4 in relation to the host aircraft 2 is known, the possibility of a future conflict is determined.

A protection region designator 20 incorporated in the collision avoidance system 14 assigns a protection region 10 around the host aircraft, based on the desired miss distance between the host and intruder aircraft and an error compensation term (defined below). The miss distance takes into account, for example, the size of the host and intruder aircraft, the likely range of any weapon systems of the intruder aircraft and the aerodynamic effects of the aircraft. From the data on the intruder aircraft state and the host aircraft position and acceleration, the collision avoidance system 14 calculates the closest point the intruder aircraft projected path 6 comes to the host aircraft 2. If the point of closest approach is outside the host aircraft projection region 10, conflict determining means 22 deem that a conflict does not exist. If the point of closest approach lies within the protection region 10, the intruder aircraft 4 is deemed to approach the host aircraft 2 too closely for safety and a conflict is registered by the collision avoidance system 14.

Once a conflict has been registered, conflict resolution means 24 calculate a host aircraft course alteration such that, after carrying out the course alteration at its current speed, the host aircraft 2 misses the intruder aircraft 4 by a safe distance. The collision avoidance system 14 centres on the intruder aircraft 4 a hypothetical protection zone 26 (shown in FIG. 3) which the host aircraft 2 is constrained to avoid. To avoid the intruder aircraft 4 by a safe distance the host aircraft 2 must touch the edge of the protection zone 26 or miss the zone 26 entirely. A radius is assigned for a spherical zone 26 based on the sum of: the desired miss distance; a constant term to account for lags in aircraft response, and an error compensation term (a heuristic based on the expected error in the estimation of the future position of the intruder aircraft, the expected error being derived from the covariance matrix of the Kalman filters for the intruder aircraft's projected path). This protection zone 26 defines lower bounds of the manoeuvre constraints of the host aircraft. The lower bounds are the area defined by the intruder aircraft in the air space surrounding the host aircraft. They form a square 28 that circumscribes the centre section of the hypothetical sphere 26 surrounding the intruder aircraft 4. The upper limits of the manoeuvre constraints are usually the physical limits of the host aircraft; they form an outer boundary 30 of maximum climb, dive, left and right turn parameters that the host aircraft cannot go beyond.

The course alteration calculated by the conflict resolution means 24 is expressed in terms of acceleration and climb rate. The acceleration is integrated to provide a vector and the collision avoidance system 14 outputs a resolution vector and the time needed to achieve it to a display. A pilot then implements the course alteration to avoid the intruder aircraft 4. Alternatively, the collision avoidance system 14 may output the avoidance manoeuvre to an automatic steering device, e.g. autopilot. The autopilot may be arranged to return the host aircraft 2, once the avoidance manoeuvre has been carried out, to the desired vector in which it was initially heading.

Typically, the collision avoidance system 14 requests a helical manoeuvre with constant speed, climb rate and rate of turn to avoid a conflict, as such a manoeuvre requires an approximately constant trim, so even if the host aircraft 2 cannot change its rate of turn instantly, the aircraft 2 should stabilise quickly compared to the time the manoeuvre takes.

If no solution can be found by the conflict resolution means 24 at the current host aircraft speed, the calculations are repeated using a slower speed. If still no solution is found or in the event that the intruder aircraft 4 is first detected within the host vehicle protection region 10, the conflict resolution means 24 is adapted to select an emergency manoeuvre, typically consisting of a turn, at a fraction of the current speed, onto a path orthogonal to the intruder vehicle flight path in the direction involving the least magnitude heading change. Such an emergency manoeuvre overrides any other host vehicle manoeuvre requests.

The manoeuvre constraints restrict the space from which the conflict resolution means 24 can select a course. The conflict resolution means 24 also takes into account the capabilities of the host aircraft, ground and weather avoidance, and the rules of the air which are preprogrammed into the system. A cost heuristic is used to select the best allowable course alteration. The best manoeuvre is taken to be that with the gentlest constant trim and which causes the host aircraft to avoid entering the intruder aircraft protection zone 26. As such, the manoeuvre lasts until the closest approach and the host aircraft path touches the edge of the intruder aircraft protection zone 26. If the intruder estimation is wrong or the intruder manoeuvres, choosing the gentlest manoeuvre means there should be more manoeuvrability available to the host aircraft 2 to avoid new situations. The cost heuristic is based on the weighted sum of the squares of the difference in climb rate and turn rate between the manoeuvre and either the desired vector of the host aircraft 2 or the straight and level, with the weights chosen as desired, for example to favour turning. The cost heuristic may additionally take into account time and/or fuel expenditure resulting from the course alteration.

By calculating a quadratic approximation of the expected difference between the positions of the host aircraft 2 and intruder aircraft 4 in the earth axis coordinate system at a future time, the rate of change of the square of the range may be calculated. The time when the host aircraft 2 most closely approaches the intruder aircraft 4 can then be calculated. The conflict determining means 22 subsequently determines the existence of conflict only when the calculated critical time is positive. If the critical time is found to be negative, the intruder aircraft 4 is deemed to be moving away from the host aircraft 2 and is therefore not in conflict.

Having now described various embodiments in accordance with the invention, numerous modifications will become apparent to the skilled person. The system may be used with any type of vehicle where it is necessary to sense and avoid other vehicles, such as in three dimensions submarines, and in two dimensions ships or land vehicles.

It will be understood that the host vehicle protection region and the intruder vehicle protection zone may be spherical or any other shape and may or may not be located centrally around the host vehicle. Intruder vehicles in front of the host vehicle may be considered more of a threat than those behind the host vehicle due to their higher closing speed.

The host vehicle protection region and the intruder vehicle protection zone may be formed taking characteristics of the intruder vehicle into account, such as the size, speed or aerodynamic effects of the vehicle or whether it is a cargo or military vehicle. The collision avoidance system therefore may include means for determining the type of intruder vehicle and assign the size of the protection region or zone accordingly.

For host vehicles slow to respond to requests to change rate of turn, the collision avoidance system may be adapted to request a higher rate of turn than that required for avoidance until the rate of turn matches that required.

It is advantageous for the collision avoidance system to evaluate all potential and actual intruder conflicts within the predetermined region around the host vehicle and to calculate manoeuvre constraints to avoid all intruder vehicles that the host vehicle has data for. The collision avoidance system can combine the manoeuvre constraints for each of the multiple intruders and select a course alteration from the remaining possible alterations to give an optimum path, as described above, for the host vehicle such that the host vehicle will avoid all intruders. This avoids the calculation of a host vehicle course alteration which will avoid one intruder vehicle currently in conflict with the host vehicle but bring the host vehicle into conflict with another intruder vehicle.

1. A method for avoiding a collision between a host vehicle and an intruder vehicle comprising the steps of:
detecting an intruder vehicle within a predetermined region around the host vehicle and collecting data on the intruder vehicle position over time;
predicting a projected path of the intruder vehicle using a quadratic extrapolation of the intruder vehicle position data;
assigning a protection region around the host vehicle, and
determining if the intruder vehicle projected path will intercept the host vehicle protection region and thereby determining if there will be a conflict.

2. A method for avoiding a collision between a host vehicle and an intruder vehicle as claimed in claim 1 further comprising the step of:
on determining that there will be a conflict between the host vehicle and the intruder vehicle, calculating an alteration of the host vehicle course such that the intruder vehicle projected path will not intercept the host vehicle protection region.

3. A method for avoiding a collision between a host vehicle and an intruder vehicle as claimed in claim 1 further comprising the steps of:
on determining that there will be a conflict between the host vehicle and the intruder vehicle, assigning a protection zone around the intruder vehicle, and
calculating an alteration of the host vehicle course such that the host vehicle will not intercept the intruder vehicle protection zone.

4. A method for avoiding a collision between a host vehicle and an intruder vehicle as claimed in claim 2 or 3 further comprising the step of:
outputting the course alteration as a resolution vector to a display means or an automatic steering device.

5. A method for avoiding a collision between a host vehicle and an intruder vehicle as claimed in any of claims 2 to 4 wherein the calculation of a host vehicle course alteration takes into account host vehicle characteristics and any course alterations that do not comply with these characteristics are discarded.

6. A method for avoiding a collision between a host vehicle and an intruder vehicle as claimed in any preceding claim further comprising the step of:
in the event a conflict has been determined, calculating the time at which the intruder vehicle projected path is closest to the host vehicle.

7. A method for avoiding a collision between a host vehicle and an intruder vehicle as claimed in any of claims 2 to 6 further comprising the step of:
selecting a course alteration such that at least one of time expenditure, fuel expenditure or change in direction of the host vehicle resulting from the course alteration is minimised.

8. A method for avoiding a collision between a host vehicle and an intruder vehicle as claimed in any of claims 2 to 6 further comprising the step of:
on detecting an intruder vehicle within the host vehicle protection region, selecting an emergency course alteration.

9. A method for avoiding a collision between a host vehicle and an intruder vehicle as claimed in any preceding claim for detecting multiple intruder vehicles, further comprising the step of storing the multiple intruder vehicle position data.

10. A method for avoiding a collision between a host vehicle and an intruder vehicle as claimed in claim 9 when dependent on any of claims 2 to 8 further comprising the step of:
calculating a host vehicle course alteration which will avoid conflict with all intruder vehicles.

11. A collision avoidance system for a host vehicle comprising:
detecting means adapted to detect an intruder vehicle within a predetermined region around the host vehicle and collect data on the intruder vehicle position over time;
means for predicting a projected path of the intruder vehicle using a quadratic extrapolation of the intruder vehicle position data;
means for assigning a protection region around the host vehicle, and
conflict determining means adapted to determine if the intruder vehicle projected path will intercept the host vehicle protection region and thereby determine if there will be a conflict.

12. A collision avoidance system as claimed in claim 11 further comprising:
conflict resolution means adapted to calculate, on determining that there will be a conflict between the host vehicle and the intruder vehicle, an alteration of the host vehicle course such that the intruder vehicle projected path does not intercept the host vehicle protection region.

13. A collision avoidance system as claimed in claim 11 further comprising:
conflict resolution means adapted to assign, on determining that there will be a conflict between the host vehicle and the intruder vehicle, a protection zone around the intruder vehicle and to calculate an alteration of the host vehicle course such that the host vehicle does not intercept the intruder vehicle protection zone.

14. A collision avoidance system as claimed in claim 12 or 13 wherein the conflict resolution means takes into account host vehicle characteristics and in use is adapted to discard any course alterations that do not comply with these characteristics.

15. A collision avoidance system as claimed in any of claims 12 to 14 further comprising:
means adapted, in the event a conflict has been determined, to calculate the time at which the intruder vehicle projected path is closest to the host vehicle.

16. A collision avoidance system as claimed in any of claims 12 to 15 wherein the conflict resolution means is adapted to select a course alteration such that at least one of time expenditure, fuel expenditure or change in direction of the host vehicle resulting from the course alteration is minimised.

17. A collision avoidance system as claimed in any of claims 12 to 15 wherein the conflict resolution means is adapted to select, on detecting an intruder vehicle within the host vehicle protection region, an emergency course alteration.

18. A collision avoidance system as claimed in any of claims 12 to 17 for use in the detection of multiple intruder vehicles, further comprising means for storing the multiple intruder vehicle position data.

19. A collision avoidance system as claimed in claim 18 adapted to calculate a host vehicle course alteration which will avoid conflict with all intruder vehicles.

20. A vehicle having a collision avoidance system as claimed in any of claims 10 to 17.
